(19) United States
(12) Patent Application Publication
(10) Pub. No.: US 2004/0185686 A1
(43) Pub. Date: Sep. 23, 2004

(54) Flat flexible connecting wire with a connector

(75) Inventors: Kun-Ju Hsieh, Taoyuan Shien (TW); Wen-Ping Liu, Taoyuan Shien (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Delta Electronics, Inc., Taoyuan Shien (TW)

(21) Appl. No.: 10/797,769

(22) Filed: Mar. 10, 2004

(30) Foreign Application Priority Data
Mar. 17, 2003 (TW) 092204078

(51) Int. Cl. H01R 12/00

(52) U.S. Cl. 439/67

(57) ABSTRACT

This invention provides a flexible connecting wire with a connector including a flat flexible cable and a engaging structure. A main body and an electrical contact surface are arranged in the flat flexible cable. The engaging structure has a engaging body. The width of the engaging body is approximately larger than width of the main body. The engaging body has one or more fixing flanges. Between the fixing flange and the engaging body is a gap which is approximately larger than thickness of main body. The main body and the engaging structure are compactly assembled by external force. The thickness of the connector is slight bigger than the height of insertion hole of a receptacle so that electrical coupling and compact assembly are formed when the connector in flexible connecting wire is inserted into the receptacle.

### FIELD OF THE INVENTION

The present invention relates to a flexible connecting wire, and especially to a flat one which is made by combining a engaging structure with flexible cable, which has function of a connector after combination, and which has the same low cost advantage as a flexible cable so that the connecting wire can be plugged into and electrically coupled to a connector receptacle or a socket or a header in order to make the flexible connecting wire versatile and to efficiently decrease cost of the connecting wire.

### BACKGROUND OF THE INVENTION

The flat displays, such as, a liquid crystal display, and notebooks trend to become thinner and thinner in thickness. Because the liquid crystal display panel module is the main component of the flat display, panel modules must trend to be thinner. A connector receptacle (please see FIG. 3) must be deposed at the back of the liquid crystal display panel module and can be connected to the outside device by a wire so that the circuit in the display panel module can be coupled to the outside circuit.

Please refer to FIGS. 1 and 2. FIGS. 1 and 2 respectively shows a side view and front view of a conventional wire. The manufacturing method and disadvantages of the conventional wire in present frame structure are as follows: The present manufacturing method of the conventional wire is to % combine a conventional electrical wire, terminals and a single-row flat connector into a coupling wire. The assembly of the coupling wire is very complicated includes steps of stripping polyvinyl chloride skin of the traditional electrical wire to expose inside copper lines, connecting the terminals of the single-row flat connector to copper lines by riveting, and assembling the semi-finished product of the traditional riveted wire with a single-row flat connector by welding. The drawbacks of the conventional wire are as follows: (1) The conventional wire are processed by a large amount of labor force, which causes quality control problem by man-made fault, such as bad riveting of the electric wire (the riveting is not secure and easily loosened, and tight riveting cause the copper lines broken, etc.), high failure rate of connection between the riveted wire and the single-row flat connector (the faulty insertion of copper lines, and insufficient retaining force after insertion, etc.), etc. Therefore, in order to solve the above problem, this invention provides a flexible connecting wire with connector which can be plugged into various connector sockets as needed. This invention especially provides a thin and cheap connecting wire which can save labor force and increase quality stability during assembly.

### SUMMARY OF THE INVENTION

The main object of the present invention is to provide a flexible connecting wire with a connector by means of combination of engaging structure and flat flexible cable such that the flexible connecting wire with the connector can be plugged into and connected to a general receptacle for making the flexible connecting wire with the connector versatile and for decreasing production cost.

It is another object of the present invention to provide a flexible connecting wire with a connector, and especially to provide one in which a engaging structure is mounted on an outside portion of a flat flexible cable. The engaging structure is made of metal or non-metal materials for inserting into a receptacle or a socket or a header of a single-row flat connector, such as JAE FI-X series, LG GT101 series, etc. Because the flat flexible cable can be conveniently processed by automatically mass production and at low cost, it replaces the conventional polyvinyl chloride wire which needs complex processes at high cost. The gist is to provide a engaging structure used to match with and to connected to different receptacles of a single-row flat connector easily.

In order to achieve the above objects, this invention is implemented by providing a flexible connecting wire with connector including a flat flexible cable and a engaging structure. The flat flexible cable has a main body and an electrical contact surface. The engaging structure has a engaging body with a width slightly larger than that of the main body.

The engaging body has one or more fixing flange. Between the fixing flange and the engaging body is formed a gap which is slightly larger than the thickness of main body. The main body and the engaging structure are compactly secured by an external force. The thickness of the connector is slightly bigger than that of the receptacle to facilitate formation of electrical coupling and compact combination when connector of the flexible connecting wire is inserted into the receptacle.

The present invention may be best understood through the following description with reference to the accompanying drawings, in which:

### BRIEF DESCRIPTION OF THE DRAWINGS

FIG. 1 is a side view illustrating the conventional wire of a prior art;

FIG. 2 is a top view illustrating the conventional wire of a prior art;

FIG. 3 is a rear elevation of a flat display according to the present invention.

FIG. 4 is a schematic diagram illustrating a flat flexible connecting wire with a connector according to a preferred embodiment;

FIG. 5 is a schematic diagram illustrating an exploded view of a flat flexible connecting wire with a connector according to a preferred embodiment of the present invention.

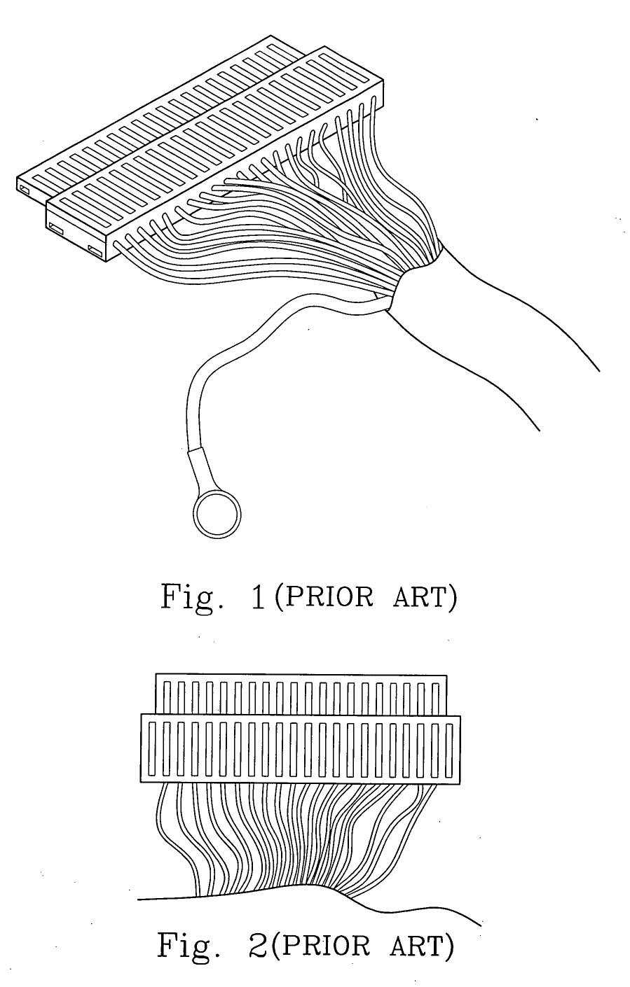

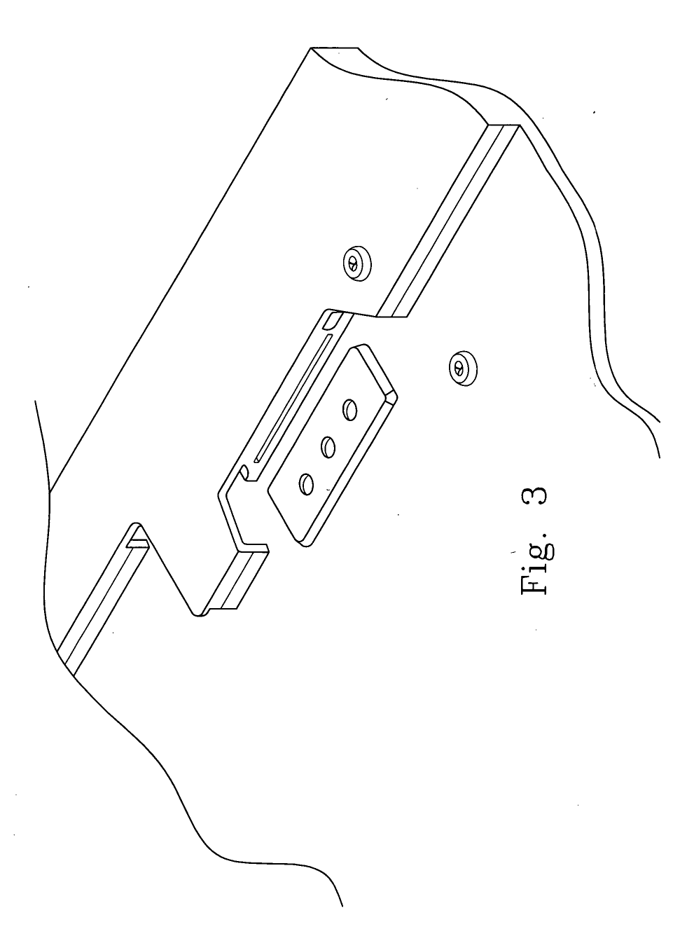

### DETAILED DESCRIPTION OF THE PREFERRED EMBODIMENT

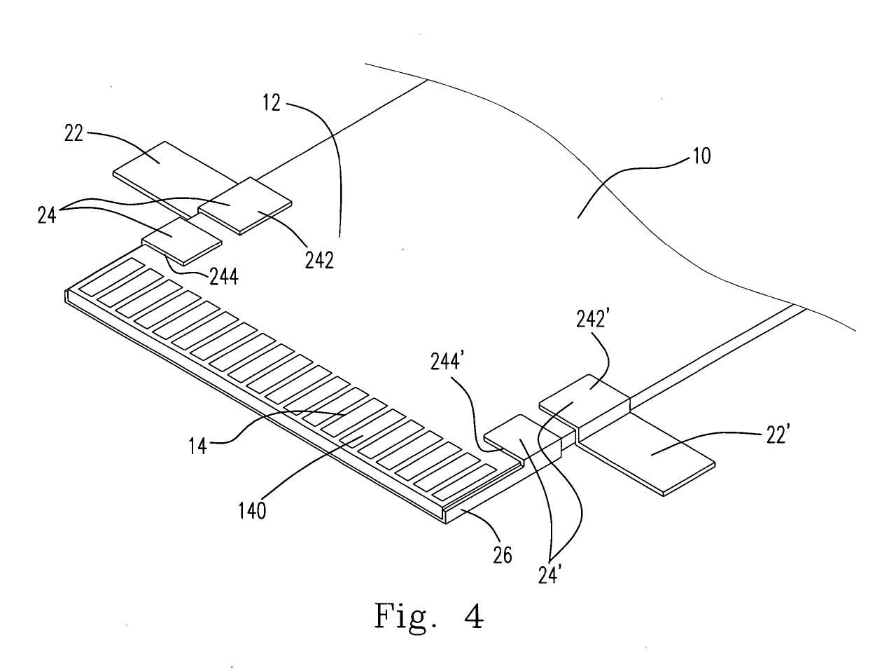

The present invention will now described more specifically with reference to the following embodiments. Please refer to FIG. 4. FIG. 4 is an isometric view showing the present invention. The flexible connecting wire with a connector of the present invention includes a flat flexible cable 10 and a engaging structure 20. The flat flexible cable 10 has a main body 12 and an electrical contact surface 14. On the electrical contact surface 14 are a plurality of connecting terminals 140. Polyvinyl chloride skin covers main body 12 on its surface. There are many conductive lines inside of the main body 12.

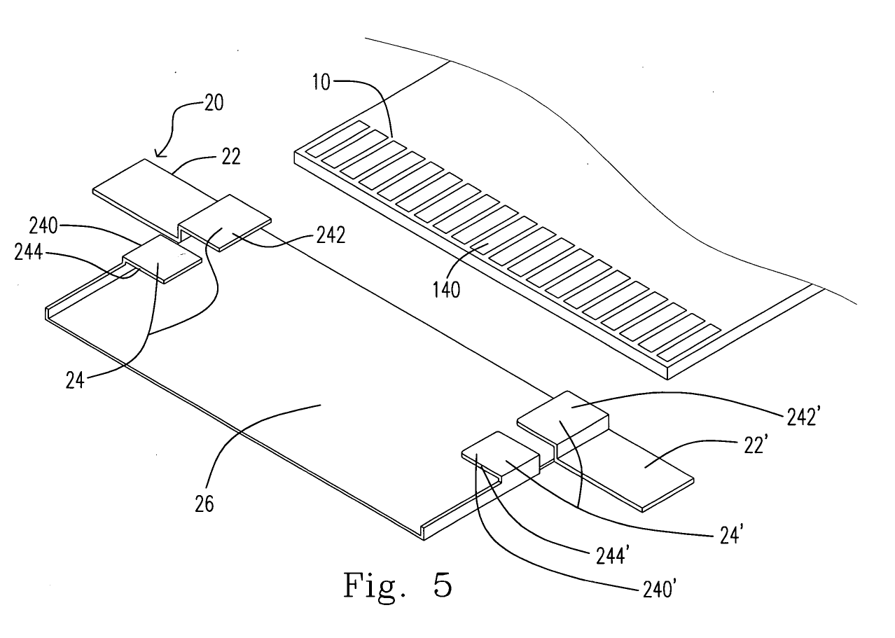

Please refer to FIG. 5. FIG. 5 is an exploded view of the flexible connecting wire with a connector of the present invention. The engaging structure 20 is consisted of engaging body 26 and first securing portion 24 and second securing portion 24′ respectively disposed at both sides of the engaging body 26. The width of the engaging body 26 is a little bit larger than that of the main body 12. The shape of engaging body 26 is rectangle. The first and second securing portion 24, 24′ respectively include first fixing flanges 240, 240′ and second fixing flanges 242, 242′. A gap is formed between first and second fixing flanges 240, 240′, 242, 242′ and the engaging body 26. The gap is slightly bigger than the thickness of the main body 12.

Please see FIG. 4. When the engaging structure 20 and the flat flexible cable 10 are combined, an end of the electrical contact surface 14 on the flat flexible cable 10 is entered into the gap between the first fixing flanges 240, 240′ and the second fixing flanges 242, 242′ and the engaging body 26. The edge near a connecting terminal 140 of the main body 12 protrude beyond the front end 244, 244′ of the first fixing flanges 240, 240′ so that the engaging body 26 align the front edge of the electrical contact surface 14. In this way, the total thickness of the engaging body 26 and the electrical contact surface 14, which is approximately larger than the thickness of the receptacle, increases.

The engaging structure 20 may be made in the following way: (1) cutting step: cutting suitable materials, such as metal, by a punching machine into a semi-finished product having a size which meets the structural body of the engaging structure; (2) glue step: before laminating the engaging structure 20 on the flat flexible cable 10, glue is uniformly applied to a connecting layer (under the bottom surface of the engaging structure and on the securing portion) between engaging structure 20 and the flat flexible cable; (3) laminating step: after glue is applied, the half-finished product temporarily glued is pressed and laminated by hydraulic or pneumatic means.

In using this invention, the connecting wire obtained by combining the engaging structure 20 and the flat flexible cable 10 is inserted into a connector receptacle, and then a plurality of connecting terminals 140 at electrical contact surface 14 are coupled to the terminals inside the receptacle in a liquid crystal display. Because the thickness of the connecting wire obtained by combining electrical contact surface 14 and engaging structure 20 is approximately bigger than that of the receptacle to form a compact assembly.

Ears 22, 22′ are respectively disposed at both sides of engaging body 26. By means of the ears 22, 22′, uniform force is applied so that more accurate alignment of electrical contact surface 14 with coupling position of internal terminals in the receptacle is achieved.

The ears 22, 22′ extend outwardly from one side of the second fixing flanges 242, 242′. In this preferred embodiment, the ears 22, 22′ to be engaged and the second fixing flanges 242, 242′ are made by monoblock casting. However, various modifications can be made to the ears, which are not limited to this preferred embodiment.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A flexible connecting wire with a connector, comprising:
a flexible cable having a main body and a electrical contact surface on which a plurality of connecting terminals are disposed; and
an engaging structure engaged with said flexible cable for providing a width and thickness so as to be inserted into a receptacle to form an electrical connection.

2. The flexible connecting wire with a connector according to claim 1, wherein said engaging structure comprises a engaging body, in which a width of said engaging body is approximately larger than a width of said main body, wherein said engaging body comprises one or more securing portion to secure said flexible cable.

3. The flexible connecting wire with a connector according to claim 2, wherein the engaging structure further comprises two ears disposed at both sides of said engaging body for applying uniform force so that more accurate alignment of the electrical contact surface with coupling position of internal terminals in said receptacle is achieved.

4. The flexible connecting wire with a connector according to claim 1, wherein said thickness is slightly bigger than a thickness of said receptacle for facilitating a formation of electrical coupling and compact combination.
